(19) United States
(12) Patent Application Publication
(10) Pub. No.: US 2007/0201651 A1
(43) Pub. Date: Aug. 30, 2007

(54) Selective caller identification blocking

(76) Inventor: Raymond Bontempi, Jamison, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 10/999,764

(22) Filed: Nov. 30, 2004

(51) Int. Cl. H04M 15/06

(52) U.S. Cl. 379/142.02

(57) ABSTRACT

A system and method for allowing a first party with Caller ID Block to selective pass its Caller ID data to desired known second parties without undue burden is disclosed. The present invention provides for a “white list”, where the “white list” includes a list of known second parties, e.g., friends and family, such that if a second party's telephone number is on the white list, the first party's Caller ID data will pass to the known second party. The white list many reside within a telecommunications switch of a telecommunications carrier or within a local digital telephony device of the first party.

### FIELD OF THE INVENTION

The present invention relates to telecommunications. More specifically, the present invention relates to caller identification blocking in telephony and/or data communication networks.

### BACKGROUND OF THE INVENTION

Caller identification (“Caller ID”) is a telephone network feature wherein the telephone number of a first party's telephony device (who initiated the call) is sent to and received by a second telephony device of a second party (the recipient of the call of the first party). The Caller ID feature is common in many telecommunications networks. The subscriber (second party) to this service is given the luxury of being able to see the telephone number of the calling party (first party). Typically, the Caller ID data is passed to the second party's telephony device between the first and second rings, indicating an incoming call.

Due to heightened privacy concerns, telecommunication carriers, e.g., telephone companies, typically allow customers to block their Caller ID information from being sent to second parties they call (“Caller ID Block”). When Caller ID Block is configured for a first party, upon a call initiated from the first party, the second party's telephony device will not receive the first party's Caller ID data, but rather a message such as “PRIVATE” or “UNKNOWN”. Currently telecommunications systems provide for only two Caller ID configuration options: (i) a first party can be configured to have their Caller ID data blocked on all calls to all second parties, or (ii) a first party can be configured to have their Caller ID data in the clear on all calls to all second parties, where here the second party would receive the Caller ID data of the first party.

These options are at two extremes, and provide no flexibility for a first party who wishes to maintain their privacy amongst unknown second parties, but wish to appropriately announce their call, via Caller ID data, to known second parties, e.g., friends, family, etc. These above two options become even more problematic when a first party with Caller ID Block initiates a call a known second party who has Caller ID Blocker, a feature that prohibits incoming calls without Caller ID data. In this case, the call of the first party will not even reach the second party unless of series of inefficient steps are performed by the first party. (Such steps may include, the first party re-dialling the known second party with a special key sequence, e.g., *80 prefix, followed by the telephone number of the second party, to disable the Caller ID block for only that instant call.)

Thus, what is needed is a system and method to allow a first party with Caller ID Block to selective pass its Caller ID data to desired known second parties without undue burden.

### SUMMARY OF INVENTION

An object of the present invention is to provide for a system and method to allow a first party with Caller ID Block to selective pass its Caller ID data to desired known second parties without undue burden.

In order to achieve this objective, as well as others which will become apparent in the disclosure below, the present invention provides for a system including a “white list”, where the “white list” includes a list of known second parties, e.g., friends and family, such that if a second party's telephone number is on the white list, the first party's Caller ID data will pass to the known second party.

In a first exemplary embodiment of the present invention, the first party, with Caller ID Block, creates a white list by identifying known second parties to the telecommunications carrier. The telecommunications carrier then automatically queries this white list when a call is placed from the first party, and passes the first party's Caller ID data only if the second party's telephone number is on the white list.

In a second exemplary embodiment of the present invention, the first party, with Caller ID Block, creates a white list, by identifying known second parties, physically in the first party's telephony device, e.g., voice over internet protocol (“VoIP”) gateway device, VoIP telephone, wireless telephone, or similar device (“digital telephony device”). Here, the digital telephony device sets a bit (“block bit”) to indicate whether the first party's Caller ID data should be sent to the second party in the instant call. The block bit is sent to the telecommunications carrier, together with the dialled telephone number, when the call is initiated. If the second party is on the white list, the block bit is automatically set by the digital telephony device to a state to indicate to the telecommunications carrier that the first party's Caller ID data is to be sent the second party.

Thus, the present system and method allows a first party with Caller ID Block to selective pass its Caller ID data to desired known second parties without undue burden.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is an illustration of a system for allowing a first party with Caller ID Block to selective pass its Caller ID data to desired known second parties without undue burden on the first party in accordance with a first exemplary embodiment of the present invention; and

FIG. 2 is a flow diagram showing the basic process flow for the selective passing of Caller ID data from a first party to a known second party in accordance with the first exemplary embodiment of the present invention;

FIG. 3 is an illustration of a system for allowing a first party with Caller ID Block to selective pass its Caller ID data to desired known second parties without undue burden on the first party in accordance with a second exemplary embodiment of the present invention; and

FIG. 4 is a flow diagram showing the basic process flow for the selective passing of Caller ID data from a first party to a known second party in accordance with the second exemplary embodiment of the present invention.

### DESCRIPTION OF A PRESENTLY PREFERRED EMBODIMENT

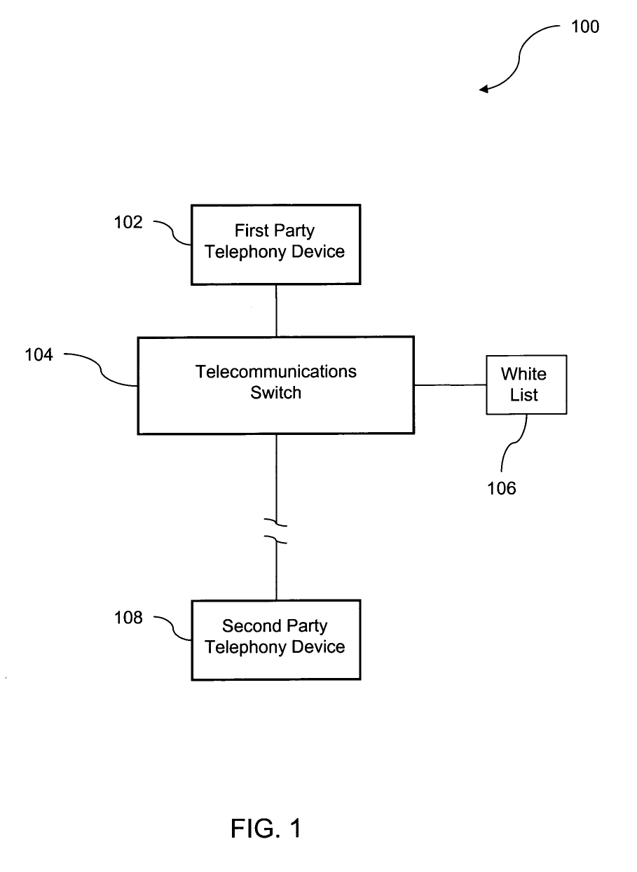

Referring to FIG. 1, system 100 is shown. System 100 is a system for allowing a first party with Caller ID Block to selective pass its Caller ID data to desired known second parties without undue burden to the first party in accordance with a first exemplary embodiment of the present invention. System 100 includes a first party telephony device (device of the party placing a telephone call) 102, a telecommunications switch 104, a white list 106, and plurality of second party telephony devices 108. For simplicity of explanation only, the present invention with be described with reference to one (1) second party telephony device 108. However, it is understood that the present invention may be implemented for one or more second party telephony devices 108, extending to the entire universe of second party telephony devices 108 capable of interconnecting to telecommunications switch 104. A second party telephony device 108 may be a conventional telephony device designed to interconnect with plain old telephone system (“POTS”) networks, wireless telephony device, e.g., GSM, CDMA device, or VoIP telephony device and/or VoIP gateway, for example, or even display devices, such as a television or television set-top box, for example, which can display Caller ID data. Similarly, the first party telephony device 102 may be a conventional telephony device designed to interconnect with POTS networks, wireless telephony device, e.g., GSM, CDMA device, or VoIP telephony device and/or gateway, for example, as long as the telecommunications carrier of the first party telephony device 102 is functionality capable of implementing the inventive white list 106 of the present invention.

In accordance with the first exemplary embodiment of the present invention, the first the capability to initiate and connect telephone calls. Similarly, the second party telephony device 108 is communicatively connected to the telecommunications switch 104 with the capability to receive incoming calls and the capability to received and display Caller ID data from inventive telecommunications switch 104. Telecommunications switch 104 (i) communicatively connects the first party telephony device 102 to the second party telephony device 108; (ii) passes the Caller ID data of the first party telephony device 102 to all second party telephony device 108 (if Caller ID Block is not configured for the first party telephony device 102); (ii) blocks the sending of the Caller ID data of the first party telephony device 102 to all second party telephony device (if Caller ID Block is configured for the first party telephony device 102), or (iii) selectively passes the Caller ID data of the first party telephony device 102 (with Caller ID Block enabled) to only known second party telephony devices 108, as determined by those second party telephony device 108 listed in the inventive white list 106. In this last instance, which is the focus of the present invention, inventive telecommunications switch 104 maintains and automatically queries the white list 106 for data associated with the first party telephony device 102, and based upon the query selectively passes the Caller ID data of the first party telephony device 102 to second party telephony devices 108. White list 106 may be a conventional relational database, or flat data table or file, and may be implemented within the telecommunications switch 104, or on a separate server (as depicted in FIG. 1).

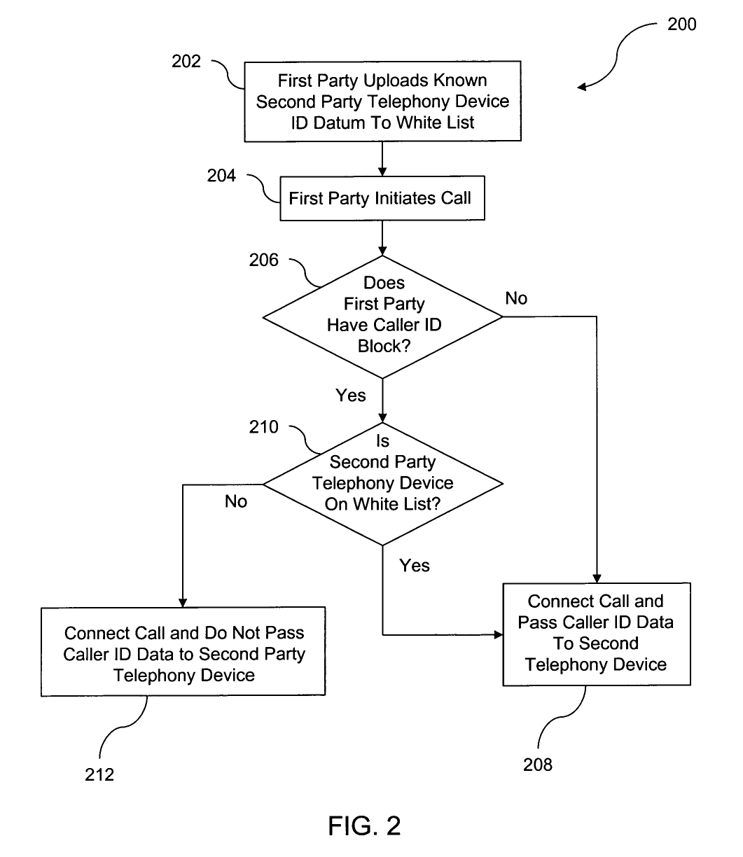

Referring to FIG. 2, in operation, the first party via its first party telephony device 102 uploads a list of known second party telephony devices' 108 identification data, such as the telephone numbers of second party telephony devices 108, to the white list 106, in step 202. Thus, the white list 106 contains a list of known second party telephony device 108 identification data (such as that of friends, family, etc.), where the first party wishes their Caller ID Block of the first party telephony device 102 to be selectively bypassed and to have the first party telephony device's 102 Caller ID data passed to the known second party telephony devices 108.

This upload step 202 can be implemented by way of a voice prompt menu when the first party calls a special number at the telecommunications switch 104 for configuration, or a web page, where the first party enters the telephone numbers of the known second party telephony devices 108, and where, upon completion, the data entered on the web page is uploaded to the white list 106 in the telecommunications switch 104. Next, when the first party initiates a call, in step 204, the telecommunication switch 104 determines if the first party has Caller ID Block, in step 206. If the first party does not have Caller ID Block the first party telephony device 102 Caller ID data is passed to the second party telephony device 108 when the telecommunication switch 104 connects the first party telephony device 102 to the second party telephony device 108 for the purpose of completing the requested call, in step 208. Typically, the Caller ID data is passed between the first and second rings to the second party telephony device 108. If the first party has Caller ID Block, the white list 106 is automatically queried to determine if the telephone number, or other identifying data, of the second party telephony device 108 is in white list 106 associated with the first party 102, in step 210. If the second party telephony device 108 identification data is on the white list 106 (a known second party), the first party telephony device 108 Caller ID data is passed to the second party 108, in step 208. If the second party telephony device 108 identification data is not on the white list 106, the call is still connected but the first party telephony device 102 Caller ID data is blocked and is not passed to the second party telephony device 108, in step 212.

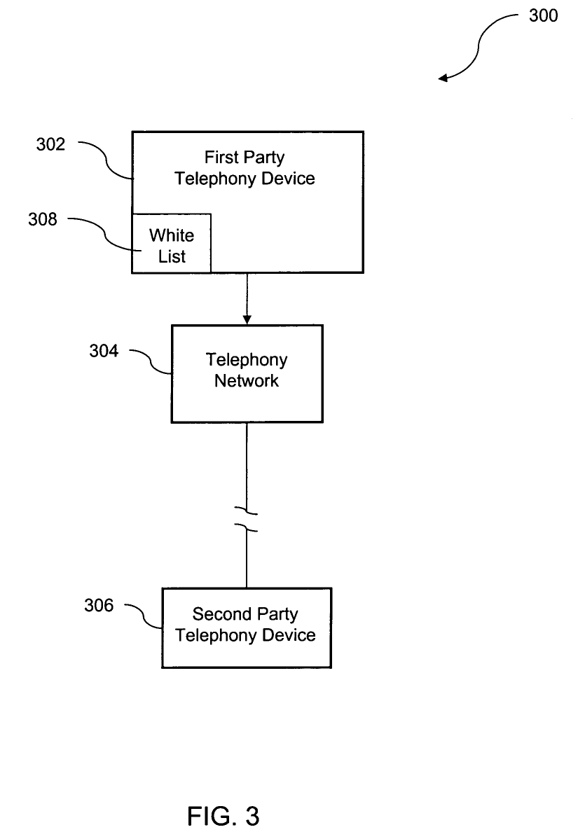

Referring to FIG. 3, system 300 is shown. System 300 is a system for allowing a first party with Caller ID Block configured for their first party telephony device to selective pass its Caller ID data to desired known second parties without undue burden on the first party in accordance with a second exemplary embodiment of the present invention. System 300 includes a first party telephony device 302 (the party placing a telephone call), an telephony network 304 for routing switching and connecting calls (comparable to the telecommunications switch 104 of the first embodiment described above), and a plurality of second parties telephony devices 306. Here, the first party telephony device 302 is preferably a digital telephony device which has the ability to retain data in non-volatile memory. VoIP telephones, VoIP gateways, and wireless telephones are preferably for a first party telephony device 302 for this exemplary embodiment. As in the first exemplary embodiment, the second party telephony devices 108 may be a conventional telephony device designed to interconnect with POTS networks, wireless telephony device, e.g., GSM, CDMA device, or VoIP telephony device and/or VoIP gateway coupled to a conventional telephone, for example, or even display devices, such as a television or television set-top box, for example, which can display Caller ID data. Again, for simplicity of explanation only, the present second exemplary embodiment will be described with reference to one (1) second party telephony device 108. However, it is understood that this embodiment of the present invention may be implemented for one or more second party telephony device 306, extending to the entire universe of second party telephony devices 306 capable of communicatively connecting to the telephony network 304. Further, the first party telephony device 302 includes a white list 308 residing in a non-volatile memory. Similar to the first exemplary embodiment, the white list 308 includes a list of known second party telephony devices 306, where the first party would like to send its Caller ID data. However, here the white list 308 is local to the first telephony device 302. The inventive telephony network 304 communicatively connects the first party telephony device 302 to the second party telephony device 306; (ii) passes the Caller ID data of the first party telephony device 302 to all second party telephony device 306 (if Caller ID Block is not configured for the first party telephony device 302); (ii) blocks the sending of the Caller ID data of the first party telephony device 302 to all second party telephony devices 306 (if Caller ID Block is configured for the first party telephony device 302), or (iii) selectively passes the Caller ID data of the first party telephony device 302 (with Caller ID Block enabled) to only known second party telephony devices 306, in response to a block bit passed to the telephony network 304 from the first party telephony device 302.

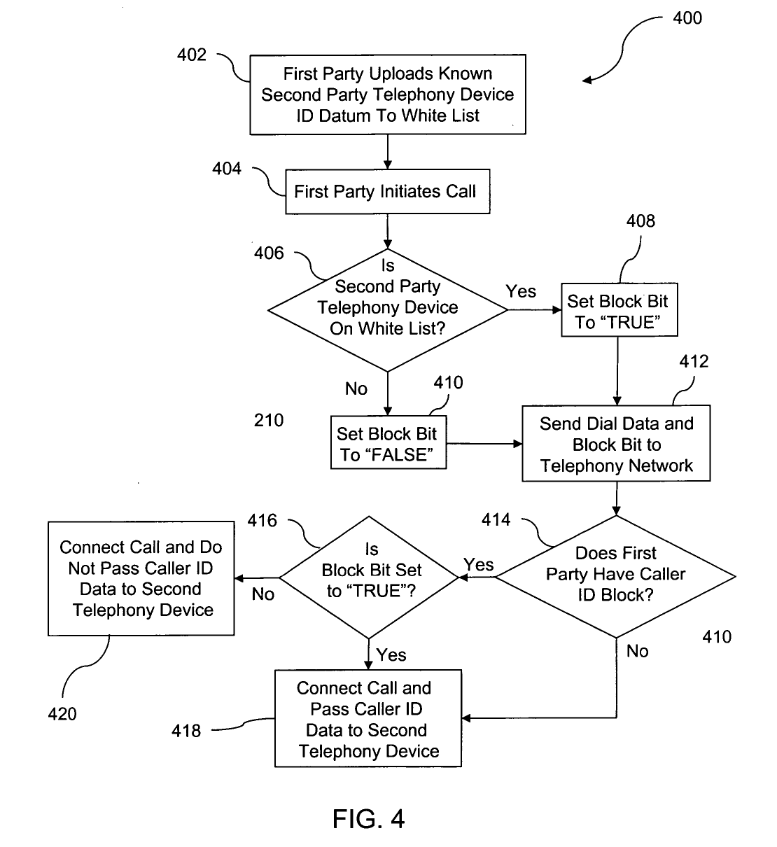

Referring to FIG. 4, in operation, the first party via its first party telephony device 302 uploads a list of known second party telephony devices' 306 identification data, such as the telephone numbers of second party telephony devices 306, to the white list 308, in step 402. Thus, the white list 308 contains a list of known second party telephony device 306 identification data (such as that of friends, family, etc.), where the first party wishes their Caller ID Block of the first party telephony device 302 to be selectively bypassed and to have the first party telephony device's 302 Caller ID data passed to the known second party telephony devices 306.

This upload step 202 can be implemented by way of a voice prompt menu on the actual first party telephony device 302, or, where the first party telephony device is a VoIP device, via a web page configuration tool (such as that commonly found on consumer Internet routers) on the first party telephony device 302. Here, the first party enters the numbers of the known second party telephony devices 306 into a white list 308, residing local to the first party. Next, when the first party initiates a call, in step 404, the first party telephony device 302, itself, will queries its white list 308, or in the case of a gateway implementation of the white list 308, the VoIP gateway, but nonetheless local to the first party telephony device 302, in step 406. If the second party telephony device 306 identification data is on the white list 308 (a known second party), the first party telephony device 302 sets a block bit with a “TRUE” state, for example “1”, in step 408, and passes the block bit and dialling data to the telephony network 304 to complete the call to the second telephony device 306, in step 412. If the second party telephony device 108 identification data is not on the white list 308, the first party telephony device 302 sets a block bit with a “FALSE” state, for example “0”, in step 410, and passes the block bit and dialling data to the telephony network 304 to complete the call to the second telephony device 306, in step 412. When the telephony network receives the block bit and dialling data, if the first caller has Caller ID Block, in step 414, the telephony network will determine the presence of a block bit and state of the block bit, in step 416. If the block bit equals a TRUE state, the telephony network 304 will connect the call and pass the Caller ID data of the first telephony device 302 to the second telephony device 306, in step 418. If the block bit equals a FALSE state, the telephony network 304 will connect the call but not pass the Caller ID data of the first telephony device 302 to the second telephony device 306, in step 420. In step 414, if the first telephony device 302 does not have Caller ID Block, then the telephony network will connect the call and pass the Caller ID data of the first party telephony device 302 to the second party telephony device 306, in step 418.

Thus, the present system and method allows a first party with Caller ID Block to selective pass its Caller ID data to desired known second parties without undue burden.

Although the invention has been described herein by reference to an exemplary embodiment thereof, it will be understood that such embodiment is susceptible of modification and variation without departing from the inventive concepts disclosed. For example, in the second exemplary embodiment of the present invention, the white list 308 may be implemented in a standalone device coupled to the first party telephony device 302, but still local to the first telephony device 302. All such modifications and variations, therefore, are intended to be encompassed within the spirit and scope of the appended claims.

We claim:

1. A system for allowing a first party telephony device, with caller identification blocked, to selectively pass caller identification data to a second party telephony device, said system comprising:
a list of second party telephony device identification datum, said list a comprising one or more datum associated with second party telephony devices; and
a telecommunications switch, said telecommunications switch communicatively connecting a first party telephony device to a second party telephony device and passing caller identification data of said first telephony device to said second telephony device if said second party telephony device identification datum associated with said second party telephony device is in said list.

2. The system of claim 1, wherein said first party telephony device comprises at least one of a plain old telephone service telephone, voice over internet telephone, voice over internet gateway, and wireless telephone.

3. The system of claim 1, wherein said second party telephony device comprises at least one of a plain old telephone service telephone, voice over internet telephone, voice over internet gateway, wireless telephone, television and television set-top box.

4. The system of claim 1, wherein said list comprises at least one of a relational database and data file.

5. A method for allowing a first party telephony device, with caller identification blocked, to selectively pass caller identification data to a second party telephony device, said method comprising the steps of:
providing second party telephony device identification datum associated with second party telephony devices which are permitted to receive the caller identification datum of a first party telephony device;
storing said provided second party telephony device identification datum in a list;
querying said list for said second party telephony device identification datum for data associated with said second party telephony device for an instant call;
providing said caller identification data of said first party telephony device to said second party telephony device, if said second telephony device identification datum of said second party telephony device is on said list; and
blocking said caller identification data of said first party telephony device to said second party telephony device, if said second telephony device identification datum of said second party telephony device is not on said list.

6. The method of claim 5 further comprising the step of determining whether said caller identification data of said first party telephony device is configured to be blocked prior to said step of querying said list for said second party telephony device identification datum of said second party telephony device for said instant call.

7. The method of claim 6 further comprising querying said list if said first party telephony device is configured to be blocked.

8. The method of claim 6 further comprising the step of providing said caller identification data of said first party telephony device to said second party telephony device, if said first party telephony device is not configured to be blocked.

9. A system for allowing a first party telephony device, with caller identification blocked, to selectively pass caller identification data to a second party telephony device, said system comprising:
a first party telephony device, said first party telephony device comparing a list of second party telephony device identification datum, said list a comprising one or more datum associated with second party telephony devices; and
a telephony network, said telephony network communicatively connecting a first party telephony device to a second party telephony device and passing caller identification data of said first party telephony device to said second party telephony device if said second party telephony device identification datum associated with said second party telephony device is in said list.

10. The system of claim 9, wherein said first party telephony device passes a block bit to said telephony network upon initiation of a telephone call.

11. The system of claim 10, wherein said block bit is set to a true state if said second party telephony device being dialled in an instant call is in said list.

12. The system of claim 10, wherein said block bit is set to a false state if said second party telephony device being dialled in an instant call is not in said list.

13. The system of claim 10, wherein upon receiving said block bit, said telephony network passes said caller identification data of said first party telephony device if said block bit equals a true state.

14. The system of claim 10, wherein upon receiving said block bit, said telephony network does not pass said caller identification data of said first party telephony device if said block bit equals a false state.

15. The system of claim 9, wherein said first party telephony device comprises at least one of a voice over internet telephone, voice over internet gateway, and wireless telephone.

16. The system of claim 9, wherein said second party telephony device comprises at least one of a voice over internet telephone, voice over internet gateway, wireless telephone, television and television set-top box.

17. The system of claim 9 wherein said list comprises a non volatile memory.

18. A computer-readable carrier including computer program instructions, to allow a first party telephony device, with caller identification blocked, to selectively pass caller identification data to a second party telephony device, that instruct a computer to perform the steps of:
providing second party telephony device identification datum associated with second party telephony devices which are permitted to receive the caller identification data of a first party telephony device;
storing said provided second party telephony device identification datum in a list;
querying said list for said second party telephony device identification datum of said second party telephony device for an instant call;
providing said caller identification data of said first party telephony device to said second party telephony device, if said second telephony device identification datum of said second party telephony device is on said list; and
blocking said caller identification data of said first party telephony device to said second party telephony device, if said second party telephony device identification datum of said second party telephony device is not on said list.

19. The computer-readable carrier of claim 18 further comprising the step of determining whether said caller identification data of said first party telephony device is configured to be blocked prior to said step of querying said list for said second party telephony device identification datum of said second party telephony device for said instant call.

20. The computer-readable carrier of claim 19 further comprising, querying said list if said first party telephony device is configured to be blocked.

21. The computer-readable carrier of claim 19, further comprising the step of providing said caller identification data of said first party telephony device to said second party telephony device, if said first party telephony device is not configured to be blocked.
